(19) United States
(12) Patent Application Publication
(10) Pub. No.: US 2014/0349837 A1
(43) Pub. Date: Nov. 27, 2014

(54) Method of Producing Fiber Catalyst and Fiber Catalyst Thereof

(71) Applicant: GUNITECH CORP., Hsinchu County (TW)

(72) Inventors: Hsin-Yi Kao, Hsinchu County (TW); Tsai-Hsin Cheng, Hsinchu County (TW); Po-Kuei Chou, Hsinchu County (TW); Ssu-Tai Lin, Hsinchu County (TW)

(73) Assignee: GUNITECH CORP., Hsinchu County (TW)

(21) Appl. No.: 14/148,802

(22) Filed: Jan. 7, 2014

(30) Foreign Application Priority Data
May 23, 2013 (TW) 102118297

(51) Int. Cl. B01J 31/08

(52) U.S. Cl. CPC B01J 31/08
USPC 502/11

(57) ABSTRACT

A method of producing a plurality of fiber catalyst is disclosed, the method includes the steps of: mixing a plurality of fiber material and a solvent to form a solution; putting the solution into a modeling container, to form at least one specific shape fiber body; applying a shaping process to the specific shape fiber body; and cutting or milling the specific shape fiber body to form a plurality of fiber catalyst.

### BACKGROUND OF THE INVENTION

1. Field of the Invention

The present invention relates to a method of producing a plurality of fiber catalysts; more particularly, the present invention relates to a method of producing hydrogen and a plurality of fiber catalysts having better reaction rates.

2. Description of the Related Art

With the gradual depletion of conventional energy in the modern society, the development of environmentally friendly new energy has received increasing attention. Among the new energy, fuel cell technology has the advantages of high efficiency, low noise, and pollution-free, which satisfy the requirements of environmental protection by modern human. Fuel cell uses the fuel as the anode which reacts with catalysts to generate hydrogen ions and electrons whereas said produced electrons travel through the electronic circuit toward the cathode and said hydrogen ions penetrate the proton exchange membrane inside the fuel cell while moving toward the cathode. The movement of electrons and hydrogen ions described above thus forms a current.

The process, which the fuel cell generates hydrogen ions, needs catalysts to accelerate the reaction of generating hydrogen. The degree of catalyst activity can affect the time to produce hydrogen and the overall structure of a fuel cell design. The catalyst used in the conventional fuel cell to produce hydrogen is a metal active site supported on an organic carrier. However, the weight of the metal active site is only 10% of overall catalysts by weight whereas the organic carrier, which can not have the reaction of producing hydrogen, accounts for most of the catalysts. Therefore, it is difficult to improve the efficiency of hydrogen production. In addition, the hydrogen production process takes place in the triple phase points of the catalyst, fuel and liquid, and, in the later stage of hydrogen production process, byproducts of hydrogen production will hinder the flow of liquid resulting in a poor reaction rate of the fuel block in the later stage.

Therefore, it is necessary to provide a new catalyst, which can be used for producing hydrogen and have a good reaction rate.

### SUMMARY OF THE INVENTION

It is an object of the present invention to provide a method of producing a plurality of fiber catalysts, especially, a method of producing hydrogen and a plurality of fiber catalysts having better reaction rates.

To achieve the abovementioned object, a method of producing fiber catalysts of the present invention includes the following steps of: mixing a plurality of fiber material and a solvent to form a solution; putting the solution into a modeling container to foam at least one specific shape fiber body; applying a shaping process to the specific shape fiber body; and cutting or milling the specific shape fiber body to form a plurality of fiber catalysts.

In the first embodiment of the present invention, the method of producing a plurality of fiber catalysts further includes the following steps of: washing the specific shape fiber body with water; and drying the specific shape fiber body after washing it with water.

In the second embodiment of the present invention, the method of producing a plurality of fiber catalysts further includes the following step of: applying a vacuum drying process to the specific shape fiber body.

In one embodiment of the present invention, the method of producing a plurality of fiber catalysts further includes the following steps of: mixing the fiber catalyst, adhesive agent, and hydrogen fuel, wherein the fiber catalyst has a first melting point, and the adhesive agent has a second melting point; and filling the mixture of fiber catalyst, adhesive agent and hydrogen fuel into a mold to be heated to a temperature that is between the first melting point and the second melting point.

In one embodiment of the present invention, the method of producing a plurality of fiber catalysts further includes the following step of: mixing the reinforcing fibers and fiber catalysts.

Another main objective of the present invention is to provide a fiber catalyst, which contains a plurality of fiber material and a plurality of cortex. The fiber material includes a plurality of specific cation-exchange functional groups and a plurality of cortex includes of a plurality of metal ions, wherein the plurality of metal ions are bonded to the plurality of specific cation-exchange functional groups. The cortex covers the fiber material.

### BRIEF DESCRIPTION OF THE DRAWINGS

FIG. 1 illustrates a flow chart of the method of producing a plurality of fiber catalysts of the first embodiment of the present invention.

FIG. 2 illustrates a flow chart of the method of producing a plurality of fiber catalysts of the second embodiment of the present invention.

FIG. 3 illustrates a schematic diagram of a plurality of fiber catalysts of the embodiment of the present invention.

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

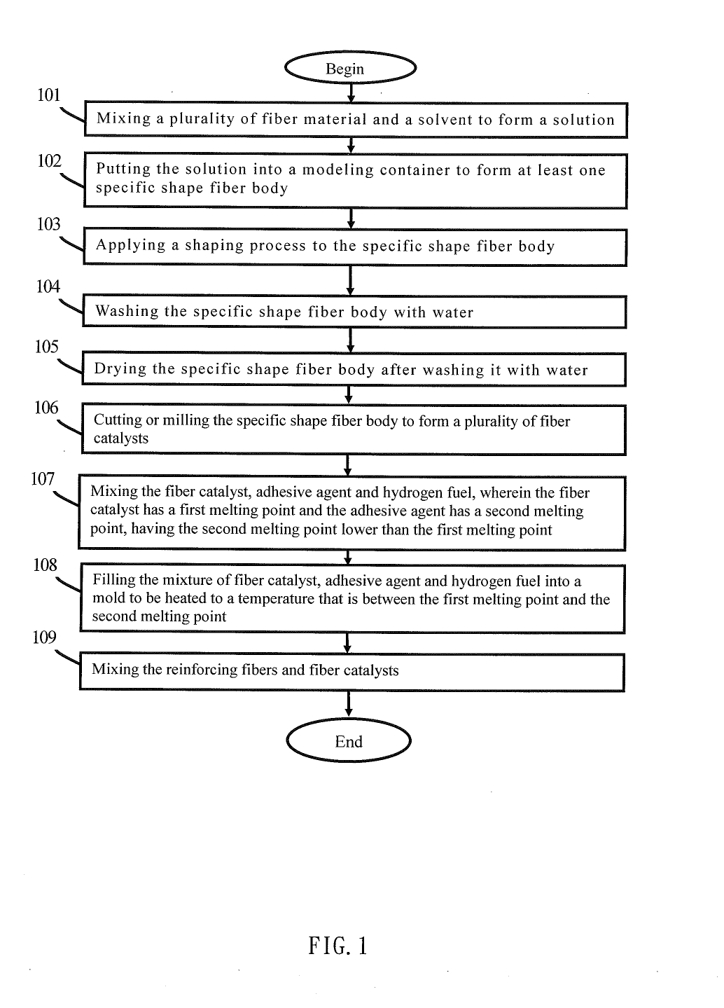

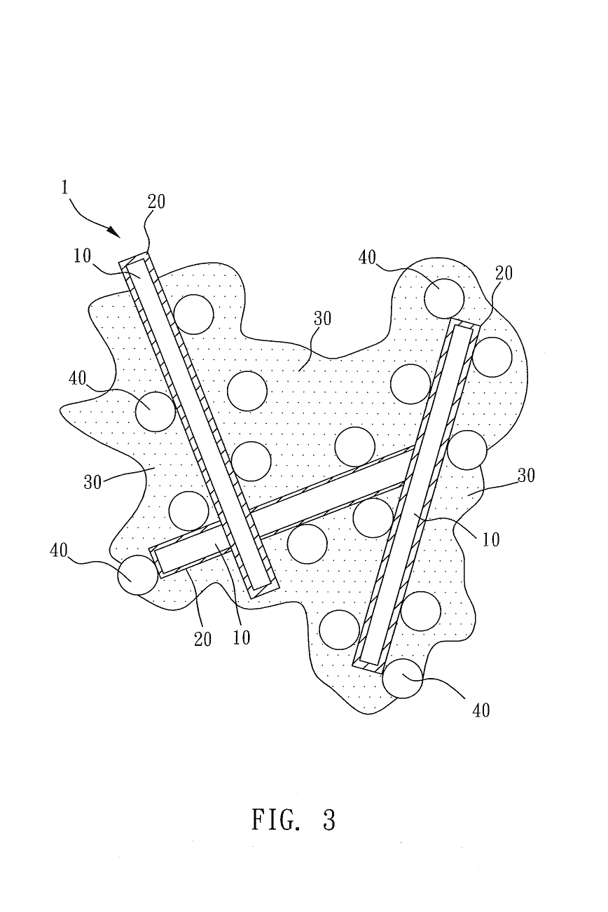

With reference to FIG. 1 and FIG. 3 of the method of producing a plurality of fiber catalysts of the first embodiment, FIG. 1 illustrates a flow chart of the method of producing a plurality of fiber catalysts of the first embodiment of the present invention; FIG. 3 illustrates a schematic diagram of a plurality of fiber catalysts of the embodiment of the present invention.

Step 101: Mix a plurality of fiber material and a solvent to form a solution.

In the first embodiment of the present invention, the plurality of fiber material 10 and a solvent are mixed and stirred to form a solution. In the first embodiment, the fiber material 10 is sodium alginate, but the fiber material 10 is not limited to sodium alginate, it can be other fiber material 10 whose structure contains specific cation-exchange functional groups, such as cellulose, hemicellulose, ligin, polyvinyl alcohol, polyacrylonitrile, polypropylene, polyethylene, polystyrene, polytetrafluoroethene, polyacrylic acid, polyvinylchloride, viscose fiber or the material selected from the group consisting of cellulose, hemicellulose, ligin, sodium alginate, chitosan, polyvinyl alcohol, polyacrylonitrile, polypropylene, polyethylene, polystyrene, polytetrafluoroethene, polyacrylic acid, polyvinylchloride, viscose fiber and a combination thereof; whereas the source of the fiber material 10 of the present invention can be, but not limited to, chitosan, natural cellulose or modified cellulose. The specific cation-exchange functional groups of the fiber material 10 of the present invention can be, but not limited to, acetate (—COO—), juan acid radical (—SO32-), phosphate (—HnPO3 (3−n) n=1, 2) or amino (—NH2). The specific cation-exchange functional groups of the fiber material 10 can be bonded to the metal ions to hold the metal ions fixedly on the fibers. The solvent of the first embodiment of the present invention is a combination of organic solvent of water, weak acid and ethanol, and however the materials of the solvent of the present invention are not limited to those described above.

Step 102: Put the solution into a modeling container to form at least one specific shape fiber body.

In the first embodiment of the present invention, the modeling container is a spinning nozzle. After the solution is put in the spinning nozzle, the solution is injected through the spinneret of the spinning nozzle to form a specific shape fiber body. In the first embodiment, the specific shape fiber body is a plurality of fiber filaments.

Step 103: Apply a shaping process to the specific shape fiber body.

In the first embodiment of the present invention, the shaping process is a coagulation bath of metal salts. The coagulation bath of metal salts of the first embodiment uses cobalt chloride solution. However, the component of the coagulation bath of metal salts of the present invention is not limited to the one described above. The metal ions used in the coagulation bath of metal salts can also be gold (Au), silver (Ag), palladium (Pd), platinum (Pt), rhodium (Rh), ruthenium (Ru), osmium (Os), iridium (Ir), Nickel (Ni), aluminum (Al), tungsten (W) or molybdenum (Mo), which can be combined with the polyvalent metal ions of the specific cation-exchange functional groups of the fiber material 10 to form a structure having special properties. After the solution is placed in the spinning nozzle and is extruded from the spinneret of the spinning nozzle, to form of a specific shape fiber body of fiber filaments, the specific shape fiber body of fiber filaments is put through the coagulation bath of metal salts immediately. Thereby, the metal ion of cobalt (Co²⁺) of the coagulation bath of metal salts can undergo ion exchange with the sodium ion (Na⁺) of the specific cation-exchange functional groups of the specific shape fiber body of the fiber material 10, and can become solidified on the surface of the specific shape fiber body of the fiber material 10, to form a water-insoluble cortex 20 of cobalt alginate (as shown in FIG. 3), in order to keep the form of the specific shape fiber body to remain fixedly. The interaction force, which causes the metal ions and the specific cation-exchange functional groups to be bonded together, is Coulomb force, chelation, or covalent bonding force. With said interaction force, the metal ions and the specific cation-exchange functional groups are bonded together, to form a ring-like structure of chelate whereas said ring-like structure of chelate can provide a good stable efficacy.

Step 104: Wash the specific shape fiber body with water.

After the specific shape fiber body has passed the coagulation bath of metal salts, the specific shape fiber body is placed and immersed in water so that the metal ions and other remaining ions of metal salts that are not bonded to the fiber material 10 in the solution are washed away.

Step 105: Dry the specific shape fiber body after washing it with water.

The specific shape fiber body is moved from water, and then is heated and dried to remove the moisture. However, the drying process of the present invention is not limited to heating and drying, and also can be freeze-dry or air-dry.

Step 106: Cut or mill the specific shape fiber body to form a plurality of fiber catalysts.

Using the method of milling or cutting, the specific shape fiber body is divided into a certain size to form a plurality of fiber catalysts 1, whereas the specific size of the present invention is 0.01 to 5 mm in length and 10-100 μm in diameter. Nevertheless, the size of the specific shape fiber body of the present invention is not limited to said sizes described above, and the size of the specific shape fiber body can change according to the design requirement.

Step 107: Mix the fiber catalyst, adhesive agent and hydrogen fuel, wherein the fiber catalyst has a first melting point and the adhesive agent has a second melting point, having the second melting point lower than the first melting point.

In the first embodiment of the present invention, the fiber catalyst 1, adhesive agent 30 and hydrogen fuel 40 are mixed together. The adhesive agent 30 of the present invention is hot melt powder and the hydrogen fuel 40 is sodium tetrahydridoborate. The fiber catalyst 1 has a first melting point; the adhesive agent 30 has a second melting point; and the second melting point of the adhesive agent 30 is lower than the first melting point of the fiber catalyst 1. However, the types of adhesive agent 30 and hydrogen fuel 40 of the present invention are not limited to those described above.

Step 108: Fill the mixture of fiber catalyst, adhesive agent and hydrogen fuel into a mold to be heated to a temperature that is between the first melting point and the second melting point.

The mixture of fiber catalyst 1, adhesive agent 30 and hydrogen fuel 40 are filled into a model to be heated to a temperature that is between the first melting point and the second melting point, to cause the adhesive agent 30 to melt. As shown in FIG. 3, the fiber catalyst 1 and hydrogen fuel 40 can be bonded to each other through the melted adhesive agent 30.

Step 109: Mix the reinforcing fibers and fiber catalysts.

The reinforcing fibers and fiber catalysts are mixed to strengthen the structure of the fiber catalysts. The reinforcing fiber of the present invention is the rayon fiber. However, the present invention is not limited to said rayon fiber and can be other fibers with strengthening efficacy.

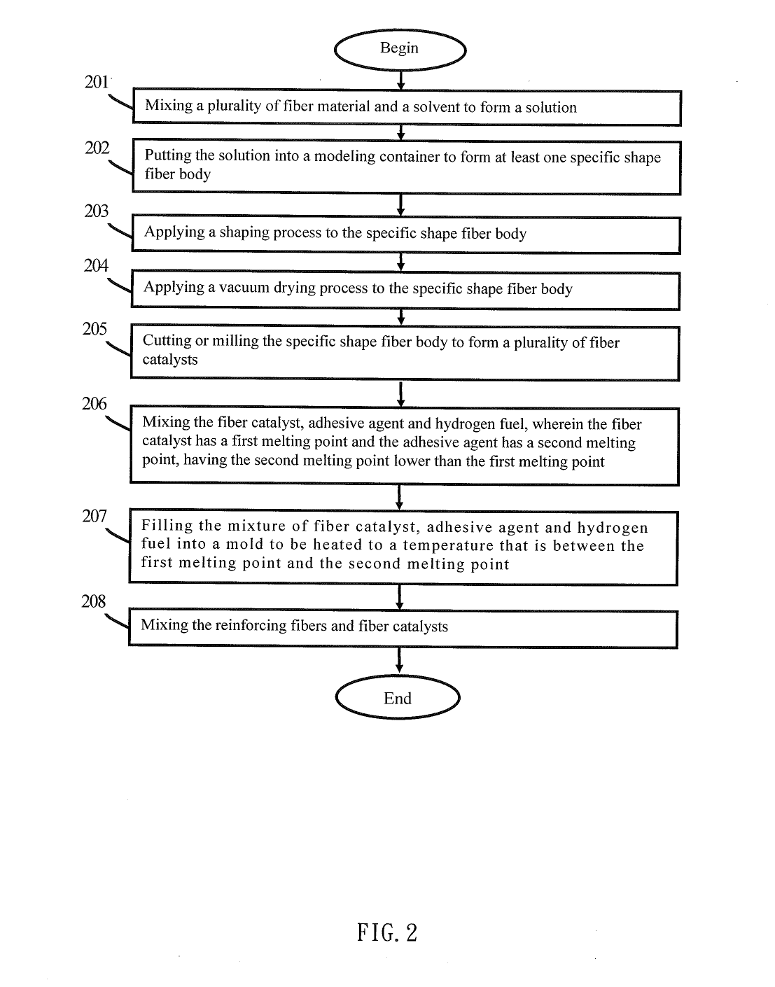

With reference to FIG. 2 and FIG. 3 of the method of producing a plurality of fiber catalysts of the second embodiment, FIG. 2 illustrates a flow chart of the method of producing a plurality of fiber catalysts of the second embodiment of the present invention.

Step 201: Mix a plurality of fiber material and a solvent to form a solution.

As shown in FIG. 2, a plurality of fiber material 10 and a solvent are mixed and stirred to form a solution. In the second embodiment, the solvent is added in advance with metal salts wherein the type of metal ions of metal salts is, for example, cobalt, gold, silver, palladium, platinum, rhodium, ruthenium, osmium, iridium, nickel, aluminum, tungsten or molybdenum. However, the type of metal ions of metal salts of the present invention is not limited to those described above.

Step 202: Put the solution into a modeling container to form at least one specific shape fiber body.

In the second embodiment, the modeling container is a rectangular parallelepiped container. After the solution is put in the rectangular parallelepiped container, the solution forms a specific shape fiber body in the shape of rectangular parallelepiped. However, the modeling container is not limited to be a rectangular parallelepiped and can also be a container of other shapes, such that after the solution is placed in the modeling container, it then forms a specific shape fiber body corresponding to the shape of the modeling container.

Step 203: Apply a shaping process to the specific shape fiber body.

In the second embodiment, the shaping process is a freezing process, wherein the specific shape fiber body placed in the modeling container is frozen into a solid state in an environment below 0° C. However, the temperature of the freezing process of the present invention is not limited to temperatures below 0° C.

Step 204: Apply a vacuum drying process to the specific shape fiber body.

In the second embodiment, after the freezing process has been applied to the specific shape of the fiber body, the specific shape fiber body undergoes a vacuum drying process in an environment below 0° C. to remove the excess moisture.

Step 205: Cut or mill the specific shape fiber body to form a plurality of fiber catalysts.

After the specific shape fiber body is removed from the modeling container, using the method of milling or cutting, such that the specific shape fiber body is divided into a certain size to form a plurality of fiber catalysts 1. The size of the specific shape fiber body of the present invention is 0.01 to 5 mm in length and 10-100 μm in diameter. However, the size of the specific shape fiber body of the present invention is not limited to said sizes described above, and the size of the specific shape fiber body can change according to the design requirement.

Step 206: Mix the fiber catalyst, adhesive agent and hydrogen fuel, wherein the fiber catalyst has a first melting point and the adhesive agent has a second melting point, having the second melting point lower than the first melting point.

In the second embodiment of the present invention, the fiber catalyst 1, adhesive agent 30 and hydrogen fuel 40 are mixed together. The adhesive agent 30 of the present invention is hot melt powder and the hydrogen fuel 40 is sodium tetrahydridoborate. The fiber catalyst 1 has a first melting point; the adhesive agent 30 has a second melting point; and the second melting point of the adhesive agent 30 is lower than the first melting point of the fiber catalyst 1. However, the types of adhesive agent 30 and hydrogen fuel 40 of the present invention are not limited to those described above.

Step 207: Fill the mixture of fiber catalyst, adhesive agent and hydrogen fuel into a mold to be heated to a temperature that is between the first melting point and the second melting point.

The mixture of fiber catalyst 1, adhesive agent 30 and hydrogen fuel 40 are filled into a mold to be heated to a temperature that is between the first melting point and the second melting point, to cause the adhesive agent 30 to melt. As shown in FIG. 3, the fiber catalyst 1 and hydrogen fuel 40 can be bonded to each other through the melted adhesive agent 30.

Step 208: Mix the reinforcing fibers and fiber catalysts.

The reinforcing fibers and fiber catalysts 1 are mixed to strengthen the structure of the fiber catalyst 1. The reinforcing fiber of the present invention is the rayon fiber. However, the present invention is not limited to said rayon fiber and can be other fibers with strengthening efficacy.

Using the method of producing the fiber catalyst 1 described above, a fiber catalyst which can generate hydrogen is produced. The fiber catalysts 1, produced in accordance with the method of the present invention, uses a natural fiber material 10 as the base material wherein the cost is low, size is small, and the hydrophilicity and porous structure are excellent in order to increase the reaction rate of generating hydrogen.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A fiber catalyst, comprising:
a plurality of fiber material, comprising a plurality of specific cation-exchange functional groups; and
a plurality of cortex, comprising of a plurality of metal ions wherein the plurality of metal ions are bonded to the plurality of specific cation-exchange functional groups and the cortex covers the fiber material.

2. The fiber catalyst as claimed in claim 1, wherein the plurality of fiber material is cellulose, hemicellulose, ligin, sodium alginate, chitosan, polyvinyl alcohol, polyacrylonitrile, polypropylene, polyethylene, polystyrene, polytetrafluoroethene, polyacrylic acid, polyvinylchloride, viscose fiber or the material selected from the group consisting of cellulose, hemicellulose, ligin, sodium alginate, chitosan, polyvinyl alcohol, polyacrylonitrile, polypropylene, polyethylene, polystyrene, polytetrafluoroethene, polyacrylic acid, polyvinylchloride, viscose fiber and a combination thereof.

3. The fiber catalyst as claimed in claim 2, wherein a source of the plurality of fiber material is chitosan, natural cellulose or modified cellulose.

4. The fiber catalyst as claimed in claim 1, wherein the plurality of specific cation-exchange functional groups can be acetate (—COO—), juan acid radical (—SO32-), phosphate (—HnPO3 (3−n) n=1, 2) or amino (—NH2).

5. The fiber catalyst as claimed in claim 1, wherein an interaction force, which causes the plurality of metal ions and the plurality of specific cation-exchange functional groups to be bonded together, is Coulomb force, chelation, or covalent bonding force and, with the interaction force, the plurality of metal ions and the plurality of specific cation-exchange functional groups are bonded together to form a ring-like structure of chelate.

6. The fiber catalyst as claimed in claim 1, wherein the plurality of metal ions are bonded to the plurality of specific cation-exchange functional groups through a shaping process whereas the shaping process is a coagulation bath of metal salts.

7. The fiber catalyst as claimed in claim 1, wherein the type of the plurality of metal ions is cobalt, gold, silver, palladium, platinum, rhodium, ruthenium, osmium, iridium, nickel, aluminum, tungsten or molybdenum.

8. A method of producing a plurality of fiber catalysts comprising the following steps of:
mixing a plurality of fiber material and a solvent to form a solution;
putting the solution into a modeling container to form at least one specific shape fiber body;
applying a shaping process to the at least one specific shape fiber body; and
cutting or milling the at least one specific shape fiber body to form a plurality of fiber catalysts.

9. The method of producing fiber catalysts as claimed in claim 8, further comprising the following steps of:
washing the at least one specific shape fiber body with water; and
applying a drying process to the at least one specific shape fiber body after washing it with water.

10. The method of producing fiber catalysts as claimed in claim 9, wherein the modeling container is a spinning nozzle; the at least one specific shape fiber body is a plurality of fiber filaments; and the shaping process is a coagulation bath of metal salts.

11. The method of producing fiber catalysts as claimed in claim 10, further comprising the following step of:
applying a vacuum drying process to the at least one specific shape fiber body.

12. The method of producing fiber catalysts as claimed in claim 11, wherein the solvent comprises a plurality of metal salts and the shaping process is a freezing process.

13. The method of producing fiber catalysts as claimed in claim 12, further comprising the following steps of:
mixing the plurality of fiber catalysts, a adhesive agent and a hydrogen fuel, wherein the fiber catalyst has a first melting point and the adhesive agent has a second melting point, having the second melting point lower than the first melting point; and
filling the mixture of the plurality of fiber catalysts, the adhesive agent and the hydrogen fuel into a mold to be heated to a temperature that is between the first melting point and the second melting point.

14. The method of producing fiber catalysts as claimed in claim 13, further comprising the following step of:
mixing a plurality of reinforcing fibers and the plurality of fiber catalysts.

15. The method of producing fiber catalysts as claimed in claim 14, wherein the fiber material is cellulose, hemicellulose, ligin, sodium alginate, chitosan, polyvinyl alcohol, polyacrylonitrile, polypropylene, polyethylene, polystyrene, polytetrafluoroethene, polyacrylic acid, polyvinylchloride, viscose fiber or the material selected from the group consisting of cellulose, hemicellulose, ligin, sodium alginate, chitosan, polyvinyl alcohol, polyacrylonitrile, polypropylene, polyethylene, polystyrene, polytetrafluoroethene, polyacrylic acid, polyvinylchloride, viscose fiber and a combination thereof, whereas the type of metal ions of the coagulation bath of metal salts is cobalt, gold, silver, palladium, platinum, rhodium, ruthenium, osmium, iridium, nickel, aluminum, tungsten or molybdenum.
